(19) United States
(12) Patent Application Publication
(10) Pub. No.: US 2016/0313910 A1
(43) Pub. Date: Oct. 27, 2016

(54) METHOD AND DEVICE FOR ORGANIZING A PLURALITY OF ITEMS ON AN ELECTRONIC DEVICE

(71) Applicant: SAMSUNG ELECTRONICS CO., LTD., Suwon-si, Gyeonggi (KR)

(72) Inventor: Saini DEEPAK, Bangalore (IN)

(21) Appl. No.: 15/036,263

(22) PCT Filed: Nov. 28, 2014
(86) PCT No.: PCT/KR2014/011588

§ 371 Date: May 12, 2016

(30) Foreign Application Priority Data
Nov. 28, 2014 (IN) 5496/CHE/2013

(51) Int. Cl. G06F 3/0488; G06F 3/01; G06F 3/0482

(52) U.S. Cl. CPC G06F 3/04883; G06F 3/0482; G06F 3/017; G06F 2203/04808

(57) ABSTRACT

A method for organizing a plurality of items on an electronic device using a gesture is provided. The method allows the user to perform the gesture on the plurality of items on the electronic device. Further, the method identifies the gesture performed on the plurality items. Furthermore, the method organizes (categorizes or de-categorizes) the plurality of items based on the identified gesture and displays the organized plurality of items to the user along with a metadata associated with each category.

### TECHNICAL FIELD

The embodiments herein relate to organizing a plurality of items in an electronic device and more particularly relate to categorizing or de-categorizing the plurality of items on the electronic device using a gesture.

### BACKGROUND ART

With the proliferation of touch screen devices, user interaction has become paramount importance to device manufactures and developers. A user of the touch screen device operates the device using a finger or a stylus. Further, the touch screen device provides a number of features and applications including, for example, a phone application, a media player application, a mapping application, a calendar application, an email application, an instant messaging application, a text messaging application, other downloadable applications, and so on to a user. Further, each application may contain number of individual items on the touch screen device. For example, messaging application includes several messages on the touch screen device. Hence, categorization of items has to be performed for each feature and application for its ease of access. For example, phonebook contacts in a smart phone are categorized based on the first letter of the contacts. Similarly, emails in an inbox can be categorized based on parameters such as priority, attachments, subject and so on.

In existing methods, the user has to follow different mechanisms to organize (categorize or de-categorize) different applications or features individually on the electronic device. For example, applications such as email, messaging, media files, and contacts and so on are organized using a specific mechanism for each application. Hence, it is difficult and inconvenient for a user while organizing different items on the electronic device.

In another existing method, though the user categorizes or de-categorizes the items on the electronic device, the user is restricted to provide inputs on a specific area of the display screen. For example, call history in the smart phones is categorized by providing user input on some specific option displayed on the screen.

### DISCLOSURE OF INVENTION

### Technical Problem

The principal object of the embodiments herein is to provide a method that allows a user to organize a plurality of items on an electronic device.

Another object of the embodiments herein is to provide a method that categorizes a plurality of items on the electronic device by identifying a gesture.

Another object of the embodiments herein is to provide a method that de-categorizes categorized items by identifying a gesture.

### Solution to Problem

Accordingly the invention provides a method for organizing a plurality of items on an electronic device. The method includes identifying at least one gesture performed by a user on the plurality of items. Further the method includes dynamically identifying at least one category for the plurality of items according to one or more relations between the plurality of items in response to the identified at least one gesture. Furthermore, the method includes organizing the plurality of items based on least one identified category.

Accordingly the invention provides an electronic device for organizing a plurality of items, the electronic device comprising an integrated circuit. Further the integrated circuit comprises a processor, a memory. The memory comprises a computer program code within the integrated circuit. The memory and the computer program code with the processor cause the device to identify at least one gesture performed by a user on the plurality of items. Further, the electronic device is configured to dynamically identify at least one category for the plurality of items according to one or more relations between the plurality of items in response to the identified at least one gesture. Furthermore, the electronic device is configured to organize the plurality of items based on least one identified category.

Accordingly the invention provides a computer program product comprising computer executable program code recorded on a computer readable non-transitory storage medium, the computer executable program code when executed, causing the actions including identifying at least one gesture performed by a user on the plurality of items. The computer executable program code when executed, causing further actions including dynamically identifying at least one category for the plurality of items according to one or more relations between the plurality of items in response to the identified at least one gesture. The computer executable program code when executed, causing further actions including organizing the plurality of items based on the at least one identified category.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1 illustrates a plurality of modules in an electronic device to organize a plurality of items in an electronic device, according to embodiments as disclosed herein;

FIG. 2 is a flow diagram illustrating a method for categorizing the plurality of items in the electronic device, according to embodiments as disclosed herein;

FIG. 3 is a flow diagram illustrating a method for de-categorizing categorized items in the electronic device, according to embodiments as disclosed herein;

FIGS. 4a-4f illustrate an example of organizing menu items when a user performs a gesture on the electronic device, according to embodiments as disclosed herein;

FIGS. 5a-5f illustrate an example of organizing call history items when a user performs a gesture on the electronic device, according to embodiments as disclosed herein;

FIGS. 6a-6g illustrate an example of organizing message inbox items when a user performs a gesture on the electronic device, according to embodiments as disclosed herein;

FIGS. 7a-7h illustrate an example of organizing email inbox items when a user performs a gesture on the electronic device, according to embodiments as disclosed herein;

FIGS. 8a-8f illustrate an example of organizing attachments when a user performs a gesture on the electronic device, according to embodiments as disclosed herein;

FIGS. 9a-9f illustrate an example of organizing contacts when a user performs a gesture on the electronic device, according to embodiments as disclosed herein;

FIGS. 10a-10f illustrate an example of organizing calendar items when a user performs a gesture on the electronic device, according to embodiments as disclosed herein;

FIGS. 11a-11f illustrate an example of organizing feeds when a user performs a gesture on the electronic device, according to embodiments as disclosed herein;

FIGS. 12a-12f illustrate another example of organizing menu items when a user performs a gesture on the electronic device, according to embodiments as disclosed herein;

FIGS. 13a-13f illustrate another example of organizing menu items when a user performs a gesture on the electronic device, according to embodiments as disclosed herein;

FIGS. 14a-14f illustrate another example of organizing menu items when a user performs a gesture on the electronic device, according to embodiments as disclosed herein; and

FIG. 15 illustrates a computing environment implementing the method to organize the plurality of items on the electronic device 100 based on a gesture, according to embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve a method to organize a plurality of items on an electronic device using a gesture. In an embodiment, the gesture can be but not limited to a touch gesture, a hover. In an embodiment, the touch gesture can be a single touch or a multi-touch input. For example, the single touch can be a tap. For example, the multi-touch can be a double tap, a scroll, a spread gesture, a pinch gesture, a two figure tap, a rotate gesture and so on.

In an embodiment, the method allows the user to perform the gesture on the plurality of items on the electronic device. Further, the method dynamically identifies one or more categories for the plurality of items according to one or more relations between the plurality of items in response to the identified one or more gestures. Furthermore, the method organizes the plurality of items based on the identified category and displays the organized plurality of items to the user along with a metadata associated with each category. In an embodiment, the metadata can be information related to number of feeds, number of unread messages, number of media files, number of downloads and so on.

One or more relations can be any criteria using which the plurality of items can be linked together.

In an embodiment, organizing the plurality of items on the electronic device may include categorizing the plurality of items into one or more categories with metadata. In an embodiment, organizing the plurality of items on the electronic device may include de-categorizing the plurality of categorized items based on the identified gesture. For example, if the user performs a pinch gesture on menu items of the electronic device, then the method categorizes the menu items such as a media player application, an email application, an instant messaging application, a text messaging application, a calendar application, different gaming applications, settings, contacts, call history and so on based on type of each item. In an embodiment, the type of item includes but not limited to Social Networking Sites (SNS), games, media, messaging and so on. In another example, if the user performs a spread gesture on the categorized menu items of the electronic device, then the method de-categorizes the categorized items.

In an embodiment, the plurality of items is organized based on relationship that exists between the plurality of items on the electronic device. For example, the menu in the electronic device contains four SNS applications (SNS 1, SNS 2, SNS 3, and SNS 4) among plurality of other items. Further, the method categorizes four SNS applications (SNS 1, SNS 2, SNS 3, and SNS 4) under a specific category as SNS since the four items belongs to the type Social Networking Sites.

In an embodiment, the method displays the plurality of items that are categorized under the specific category when the user selects that specific category by performing a gesture. For example, daily meetings, weekly meetings and monthly meetings in a calendar application on the electronic device are categorized into the specific category as meetings. When the user selects the category by using a gesture, the method displays the items that are categorized under the category 1. For example, the gesture can be a tap gesture.

In an embodiment, the method allows the user to select a set of items among plurality of items on the electronic device. Further, the method identifies the set of items among the plurality of items covered by the gesture. Furthermore, the method categorizes the set of selected items into one or more categories based on the identified gesture and displays the categorized set of items with metadata to the user. For example, if the user selects four applications among 10 menu items by performing a touch gesture. Then the method categorizes the selected four applications into one or more categories based on type of each application.

In an embodiment, the category can be predefined categories configured by the user.

In an embodiment, the predefined categories are available externally to the electronic device (SNS, online and so on).

In an embodiment, the categorization can be a real time categorization based on context of the plurality of items.

In an embodiment, the real time categorization can be performed using information available externally to the electronic device.

In an embodiment, the categorization can be a hybrid categorization using a combination of predefined categories and real time categories.

In an embodiment, the method displays the set of categorized items under a specific category when the user selects that specific category by performing a gesture on the category.

In an embodiment, the method allows the user to de-categorize the categorized set of items by performing a gesture on the electronic device. Further, the method identifies the gesture performed on the electronic device and de-categorizes the set of categorized items. For example, if the user performs a gesture on the categorized set of items, then the method de-categorizes the categorized set of items and displays the decategorized items to the user.

Unlike conventional systems, the method allows the user to organize the plurality of items by performing a gesture on any area of the display screen. Unlike the conventional systems, the method provides single mechanism to organize the plurality of items present in different applications (such as menu items, contacts, messages, emails, apps and so on) present in the electronic device. Thus, the method enhances the user experience while organizing different items on the electronic device.

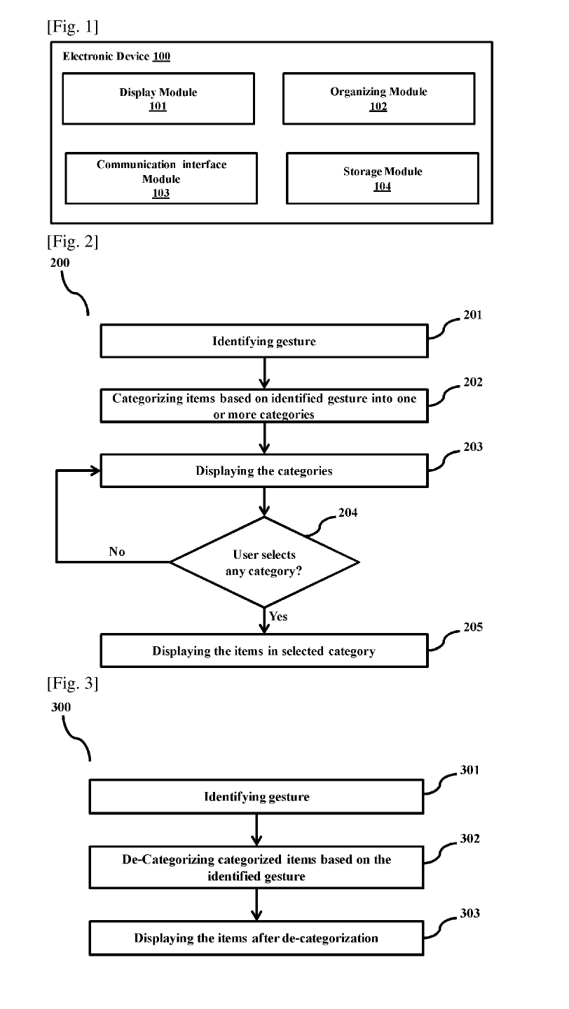

Referring now to the drawings, and more particularly to FIGS. 1 through 15, where similar reference characters denote corresponding features consistently throughout the figures, there are shown preferred embodiments.

FIG. 1 illustrates a plurality of modules in an electronic device 100 to organize a plurality of items in the electronic device 100, according to embodiments as disclosed herein. As depicted in FIG. 1, the electronic device 100 comprises a display module 101, an organizing module 102, a communication interface module 103, and a storage module 104.

In an embodiment, the display module 101 displays the plurality of items on the screen of the electronic device 100. In an embodiment, the electronic device 100 can be a touch screen device. The display allows a user to perform a gesture on the plurality of items of the electronic device 100. Further, the display module 101 displays the organized plurality of items to the user.

In an embodiment, the display module 101 displays the plurality of items that are categorized under a specific category when the user selects that specific category by performing a gesture.

In an embodiment, the display module 101 allows the user to perform a gesture to select a set of items among plurality of items on the electronic device 100. Further, the display module 101 displays the categorized set of items among the plurality of items to the user. Furthermore, the display module 101 displays the de-categorized set of categorized items to the user.

In an embodiment, the organizing module 102 can be configured to identify the gesture performed by the user on the plurality of items of the electronic device 100. In an embodiment, the organizing module 102 includes a gesture recognition module to detect the gesture. Further, the organizing module 102 can be configured to organize the plurality of items based on the identified gesture. In an embodiment, organizing the plurality of items may include categorizing the plurality of items into one or more categories with metadata. In an embodiment, organizing the plurality of items may include de-categorizing the plurality of categorized items based on the identified gesture.

In an embodiment, the organizing module 102 can be configured to associate the gesture performed on the plurality of items with categorizing the plurality of items into the specific category.

In an embodiment, the organizing module 102 can be configured to associate the gesture performed on the plurality of categorized items with de-categorizing the plurality of categorized items.

In an embodiment, the organizing module 102 can be configured to identify the gesture performed by the user on the set of items among the plurality of items on the electronic device 100. Further, the organizing module 102 can be configured to categorize the set of selected items into one or more categories with metadata based on the identified gesture. Furthermore, the organizing module 102 can be configured to de-categorize the set of categorized items based on the identified gesture.

In an embodiment, the communication interface module 103 allows the electronic device 100 to receive the updates or feeds from the SNS or the like. In an embodiment, the communication interface module 103 obtains the predefined category available in the SNS or the like.

In an embodiment, the storage module 104 stores the plurality of categorized items. Further, the storage module 104 stores association between the gesture and categorizing/de-categorizing.

FIG. 2 is a flow diagram illustrating a method 200 for categorizing the plurality of items in the electronic device 100, according to embodiments as disclosed herein. At step 201, the method 200 includes identifying a gesture on the plurality of items of an electronic device 100. The method 200 allows the organizing module 102 to identify the gesture on the plurality of items on the electronic device 100. In an embodiment, the display module 101 allows the user to perform the gesture on the plurality of items on the electronic device 100.

In an embodiment, the gesture includes but not limited to a touch gesture, a hover. In an embodiment, the touch gesture can be a single touch or a multi-touch input. For example, the single touch can include for example, but not limited to, a scroll, tangential swipe, curve swipe, single tap, multiple taps, and the likes. For example, the multi-touch can be a double tap, a scroll, a spread gesture, a pinch gesture, a two figure tap, a rotate gesture and so on.

At step 202, the method 200 includes categorizing the plurality of items based on the identified gesture. The method 200 allows the organizing module 102 to categorize the plurality of items based on the identified gesture. In an embodiment, the organizing module 102 associated the gesture with the predefined category. In an embodiment, the plurality of items is categorized based on relationship between the plurality of items on the electronic device 100. For example, inbox of the email application in the electronic device 100 contains 100 emails. In the 100 emails, 50 emails are starred, 20 emails include attachments, and 30 emails are with high priority. For example, when the user performs a pinch gesture on the inbox displayed on the screen of the electronic device 100, the method categorizes the emails with categories starred, emails having attachments, and high priority emails. The method categorizes the emails based on the relationship between the emails. For example, the emails with starred is categorized under starred category, emails with attachments as attachment category and high priority emails as high priority category. In an embodiment, the organizing module 102 categorized based on real-time categorization and allows the user to change the category name assigned by the organizing module 102.

At step 203, the method 200 includes displaying the category along with metadata. The method 200 allows the display module 101 to display the category with metadata to the user. For example, downloads in the electronic device 100 are categorized into three categories (audio files, video files and pdf files). The total number of audio files, video files and pdf files are 70, 58, and 12 respectively. Hence, the display module 101 displays the categories along with the metadata (total number of files). In an embodiment, the metadata relates to number of feeds, number of unread messages, number of media files, number of downloads and so on.

At step 204, the method 200 includes determining whether the user selects the category among the displayed categories. The method 200 allows the organizing module 102 to determine whether the user selects the category among the displayed categories.

If it is determined at step 204, that the user selects the category, then at step 205, the method 200 includes displaying the items in the selected category. The method 200 allows the display module 101 to display the items in the selected category. For example, contacts in the electronic device 100 are categorized into three categories (favorites, frequent list and most popular list). The total number of contacts in favorites, frequent list and most popular list are 120, 50, and 30 respectively. When the user selects the category most popular list, then the categorized contacts under the most popular category are displayed to the user. For example, the user selects the category using the gesture.

If it is determined at step 204, that the user has not selected the displayed category, then the method 200 again displays the categories as described in the step 203.

The various actions, acts, blocks, steps, and the like in method 200 may be performed in the order presented, in a different order or simultaneously. Further, in some embodiments, some actions, acts, blocks, steps, and the like may be omitted, added, modified, skipped, and the like without departing from the scope of the invention.

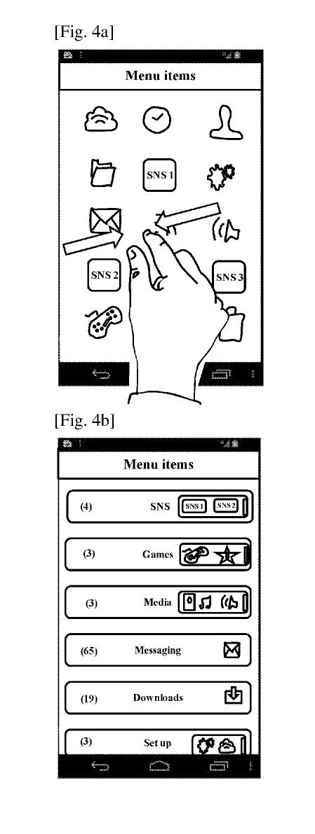

FIG. 3 is a flow diagram illustrating a method 300 for de-categorizing categorized items in the electronic device 100, according to embodiments as disclosed herein. At step 301, the method 300 includes identifying a gesture on the plurality of categorized items of an electronic device 100. The method 300 allows the organizing module 102 to identify the gesture on the category displayed on the electronic device 100. The display module 101 allows the user to perform the gesture on the category. At step 302, the method 300 includes de-categorizing the categorized plurality of items based on the identified gesture. The method 300 allows the organizing module 102 to decategorize the categorized plurality of items based on the identified gesture. For example, call history in the electronic device 100 are categorized into three categories such as missed calls, dialed calls and received calls. When the user performs gesture to de-categorize the categorized plurality of calls, the organizing module 102 decategorizes the missed call category, dialed call category and received calls category into list of calls.

At step 303, the method 300 includes displaying the categorized items after decategorization. The method 300 allows the organizing module 102 to display the categorized items after de-categorization.

The various actions, acts, blocks, steps, and the like in method 300 may be performed in the order presented, in a different order or simultaneously. Further, in some embodiments, some actions, acts, blocks, steps, and the like may be omitted, added, modified, skipped, and the like without departing from the scope of the invention.

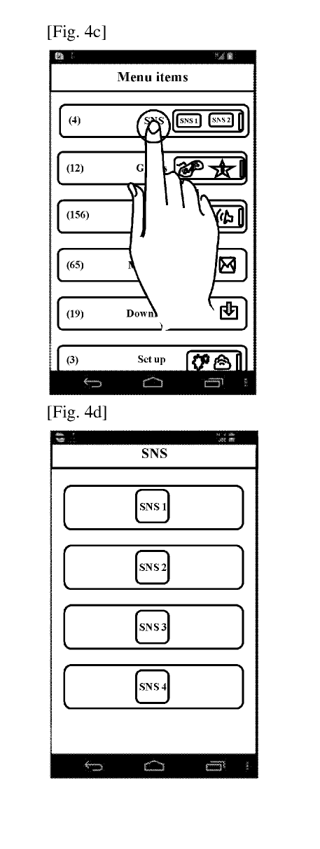

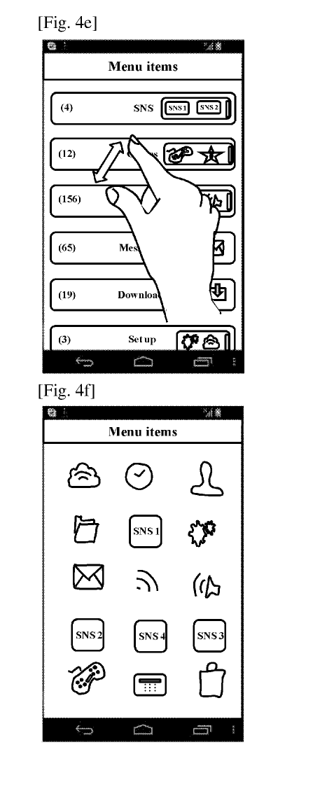

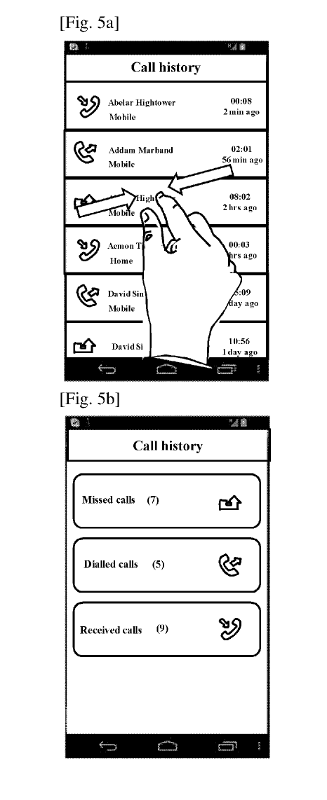

FIGS. 4a-4f illustrate an example of organizing menu items when a user performs a gesture on the electronic device 100, according to embodiments as disclosed herein. As depicted in the FIG. 4a, the electronic device 100 displays menu items such as a media player application, a mapping application, a calendar application, an email application, an instant messaging application, a text messaging application, other downloadable applications, a plurality of SNS applications, and so on. The user performs a gesture (for example, a pinch gesture) on the displayed menu items.

When the user performs a gesture (for example, a pinch gesture) on the screen of the menu items, the menu items are categorized into one or more categories with metadata as depicted in the FIG. 4b. In an embodiment, the organizing module 102 categorizes the menu items into one or more categories. As depicted in FIG. 4b, the menu items are categorized into gaming applications (3), SNS applications (4), media player applications (3), a text messaging application and an instant messaging application (65). Further, the organizing module 102 categorizes the three gaming applications under a specific category as Games, the four SNS applications under a specific category as SNS, the three media player applications under a specific category as Media, and the text messaging application and the instant messaging application under a specific category Messaging. In an embodiment, the categories can be predefined categories configured by the user. In an embodiment, the predefined categories are available externally (SNS) to the electronic device 100. In an embodiment, the categorization can be a real time categorization based on context of the plurality of items. In an embodiment, the categorization can be a hybrid categorization using a combination of predefined categories and real time categories.

As depicted in the FIG. 4c, the user selects a specific category, for example SNS, by performing a gesture (for example, a tap gesture) on the SNS category.

As depicted in the FIG. 4d, when the user selects the category SNS, the menu items that are categorized under the category SNS (SNS1, SNS2, SNS3 and SNS4) are displayed to the user.

As depicted in the FIG. 4e, the user de-categorizes the categories such as SNS, Games, Messaging and so on by performing a gesture (for example, a spread gesture) on the displayed categories. In an embodiment, the organizing module 102 decategorizes the categories.

As depicted in the FIG. 4f, when the user performs the gesture to de-categorize, then the categorized menu items are de-categorized into individual menu items as shown in the FIG. 4a.

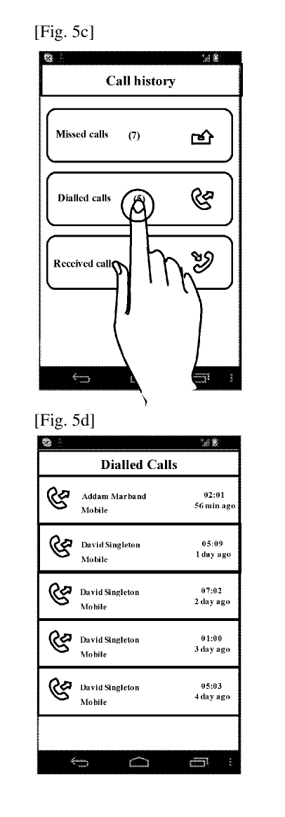

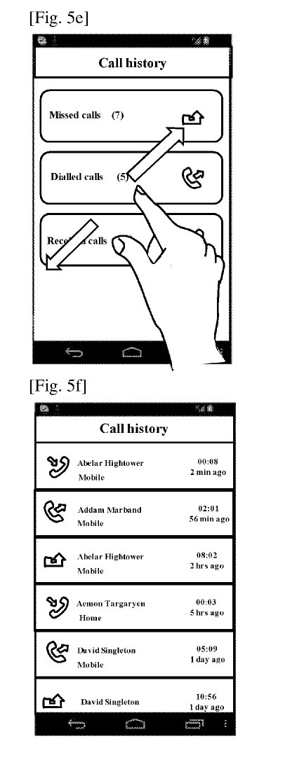

FIGS. 5a-5f illustrates an example of organizing call history items when a user performs a gesture on the electronic device 100, according to embodiments as disclosed herein. As depicted in the FIG. 5a, the call history of the electronic device 100 displays call details such as missed calls, dialed calls and received calls. The user performs a gesture (for example, a pinch gesture) on the call history.

When the user performs a gesture (for example, a pinch gesture) on the screen of the call history items, the call history items are categorized into one or more categories such as missed calls, received calls and dialed calls, as depicted in the FIG. 5b. In an embodiment, the organizing module 102 categorizes the call history items into one or more categories. In an embodiment, the categories can be predefined by the user of the electronic device 100.

In an embodiment, the categorization can be a real time categorization based on context of the plurality of items. In an embodiment, the categorization can be a hybrid categorization using a combination of predefined categories and real time categories.

As depicted in the FIG. 5c, the user selects a specific category, for example Dialed calls, by performing a gesture (for example, a tap gesture) on the Dialed calls category.

As depicted in the FIG. 5d, when the user selects the Dialed calls category, the call history items that are categorized under the Dialed call category are displayed to the user.

As depicted in the FIG. 5e, the user can de-categorize the categories such as Dialed calls, Received calls and Missed calls by performing a gesture (for example, a spread gesture) on the displayed categories.

As depicted in the FIG. 5f, when the user performs the gesture to de-categorize, then the categorized call history items are de-categorized as individual items as depicted in the FIG. 5a.

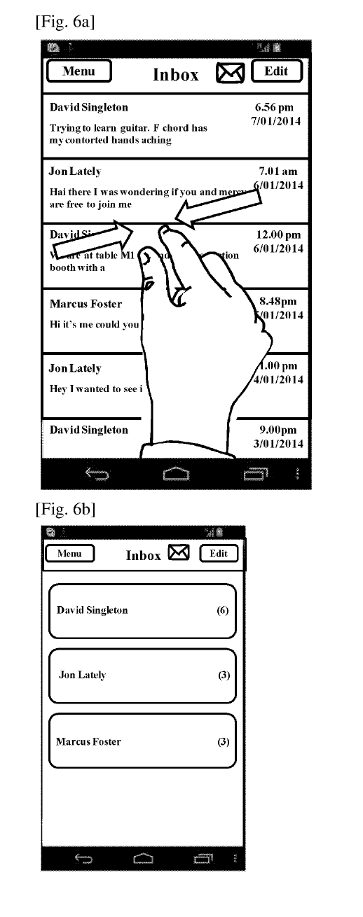

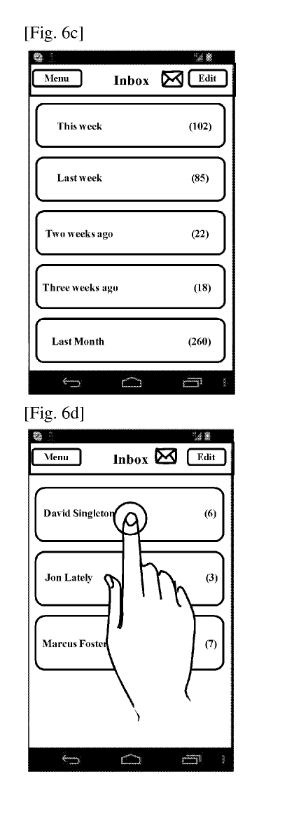

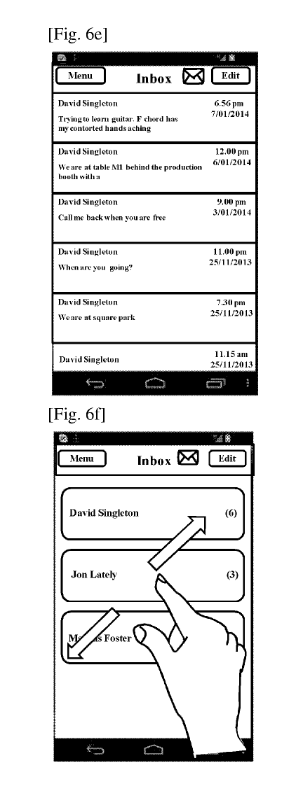

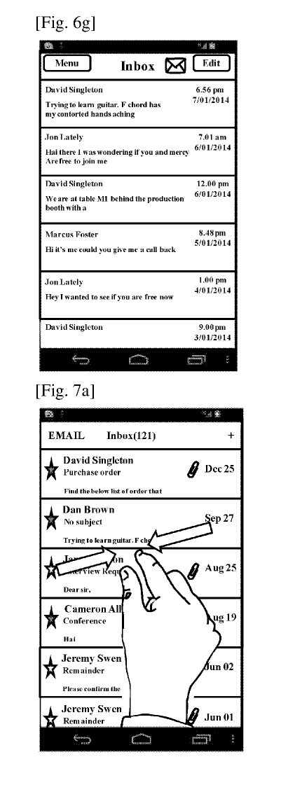

FIGS. 6a-6g illustrates an example of organizing message inbox items when a user performs a gesture on the electronic device 100, according to embodiments as disclosed herein. As depicted in the FIG. 6a, the message inbox of the electronic device 100 displays a plurality of received messages. The user performs a gesture (for example, a pinch gesture) on the messages.

When the user performs a gesture (for example, a pinch gesture) on the screen of the messages, the messages are categorized into one or more categories based on sender of the message with metadata as depicted in the FIG. 6b. In an embodiment, the organizing module 102 categorizes the messages. In an embodiment, the messages can be categorized based on received date of the messages, as depicted in the FIG. 6c.

In an embodiment, the categorization can be a real time categorization based on context of the plurality of items. In an embodiment, the categorization can be a hybrid categorization using a combination of predefined categories and real time categories.

As depicted in the FIG. 6d, the user can select a specific category, for example a category named David Singleton by performing a gesture (for example, a tap gesture) on that category named David Singleton.

As depicted in the FIG. 6e, when the user selects the category named David Singleton, the messages that are categorized in that category are displayed to the user. For example, user performs a tap gesture to selects the category.

As depicted in the FIG. 6f, the user de-categorizes the categories by performing a gesture (for example, a spread gesture) on the displayed categories.

As depicted in the FIG. 6g, when the user performs the gesture to de-categorize the categories, then the categorized messages are de-categorized as individual items as depicted in the FIG. 6a.

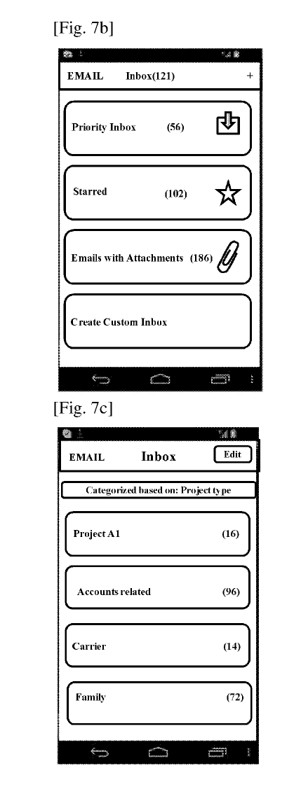

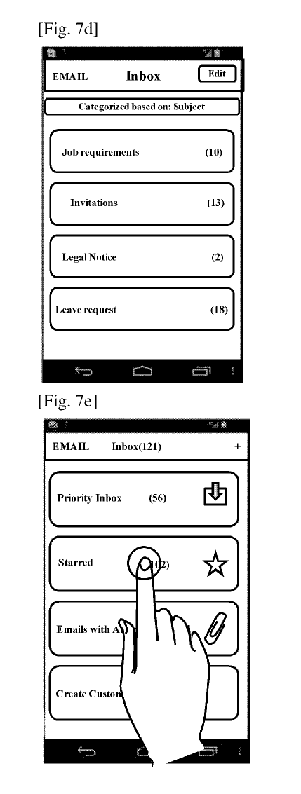

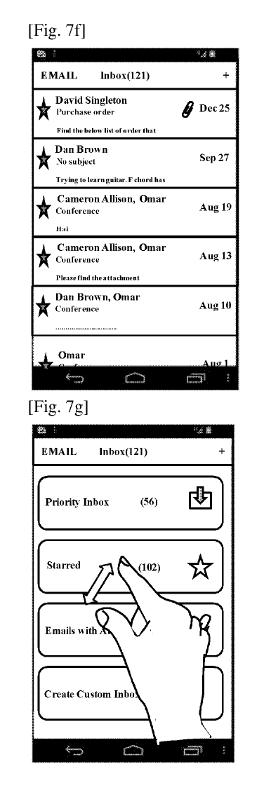

FIGS. 7a-7h illustrates an example of organizing email inbox items when a user performs a gesture on the electronic device 100, according to embodiments as disclosed herein. As depicted in the FIG. 7a, the email inbox of the electronic device 100 displays emails along with symbols of attachments, favorites, starred. The user performs a gesture (for example, a pinch gesture) on the emails.

When the user performs a gesture (for example, a pinch gesture) on the screen of the emails displayed on the electronic device 100, the emails are categorized into one or more categorizes based on high priority, starred and attachments with metadata as depicted in the FIG. 7b. The metadata includes number of emails in the category. In an embodiment, the user can predefine the categories. If the context of the email relates to projects, accounts, carrier and family, then the emails can be categorized based on project, accounts, carrier and family as depicted in the FIG. 7c. The emails can be categorized based on type of subject of the email, as depicted in the FIG. 7d. In an embodiment, the organizing module 102 categorizes the email based on the context of the emails and subject.

In an embodiment, the categories can be predefined categories configured by the user. In an embodiment, the categorization can be a real time categorization based on context of the plurality of items. In an embodiment, the categorization can be a hybrid categorization using a combination of predefined categories and real time categories.

In an embodiment, the user can change the category name after the organizing module 102 creates the categories.

As depicted in the FIG. 7e, the user can select a specific category, for example a starred category by performing a gesture (for example, a tap gesture) on that category.

As depicted in the FIG. 7f, when the user selects the starred category, then the plurality of emails that are categorized under the category are displayed to the user.

As depicted in the FIG. 7g, the user de-categorizes the categories by performing a gesture (for example, a spread gesture) on the displayed categories.

As depicted in the FIG. 7h, when the user performs the gesture to de-categorize, the categorized emails are de-categorized as individual email items as depicted in the FIG. 7a.

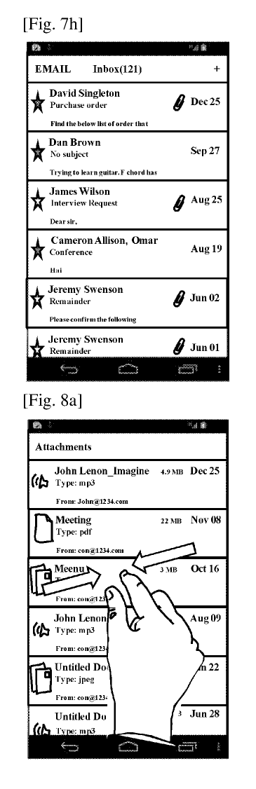

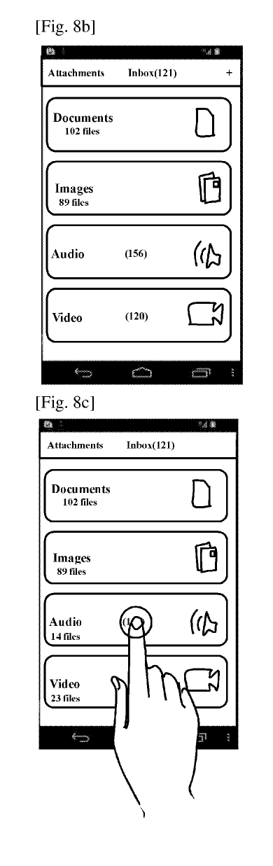

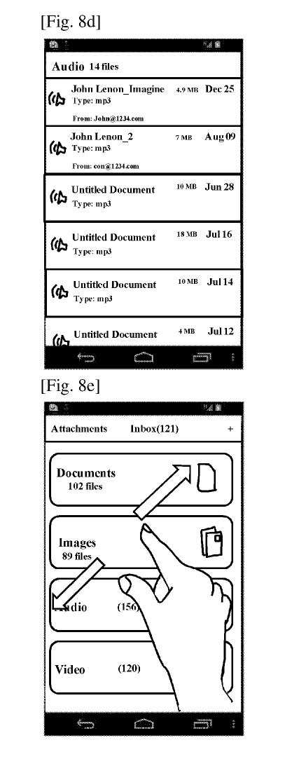

FIGS. 8a-8f illustrates an example of organizing attachments when a user performs a gesture on the electronic device 100, according to embodiments as disclosed herein. As depicted in the FIG. 8a, the electronic device 100 displays attachment items such as audio files, video files, documents, and so on. The user performs a gesture (for example, a pinch gesture) on the attachment items.

When the user performs a gesture (for example, a pinch gesture) on the displayed attachment items, the items are categorized into one or more categories with metadata as depicted in the FIG. 8b. In an embodiment, the organizing module 102 categorizes the attachment items into documents, images, audio and video.

In an embodiment, the categories can be predefined categories configured by the user. In an embodiment, the categorization can be a real time categorization based on context of the plurality of items. In an embodiment, the categorization can be a hybrid categorization using a combination of predefined categories and real time categories.

As depicted in the FIG. 8c, the user can select a specific category, for example audio, by performing a gesture (for example, a tap gesture) on that category.

As depicted in the FIG. 8d, when the user selects the category audio, the attachment items that are categorized under the category audio are displayed to the user.

As depicted in the FIG. 8e, the user de-categorizes the categories such as documents, images, audio, and video by performing a gesture (for example, a spread gesture) on the displayed categories.

As depicted in the FIG. 8f, when the user performs the gesture to de-categorize, then the categorized attachment items are de-categorized as individual attachment items as shown in the FIG. 8a.

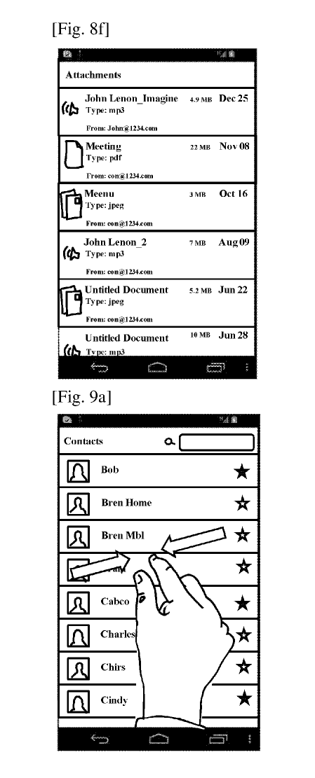

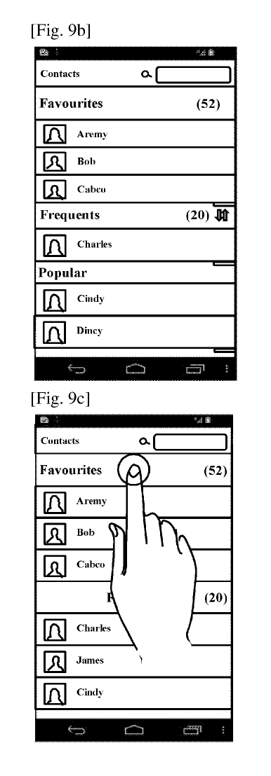

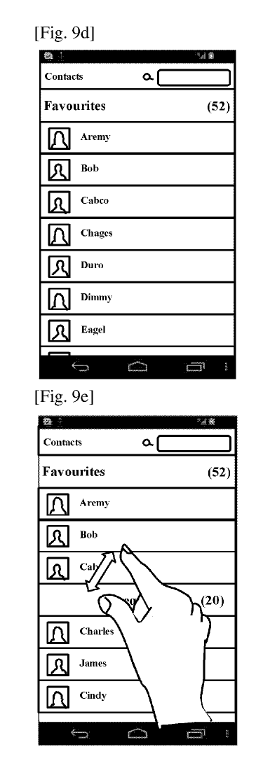

FIGS. 9a-9f illustrates an example of organizing contacts when a user performs a gesture on the electronic device 100, according to embodiments as disclosed herein. As depicted in the FIG. 9a, the electronic device 100 displays contact items. The user performs a gesture (for example, a pinch gesture) on the contact items.

When the user performs a gesture (for example, a pinch gesture) on the screen of the contact items, the items are categorized into one or more categories such as favorites, frequents and popular along with metadata as depicted in the FIG. 9b. In an embodiment, the organizing module 102 categorizes the contact items.

In an embodiment, the categories can be predefined categories configured by the user. In an embodiment, the predefined categories are available externally to the electronic device 100. In an embodiment, the categorization can be a real time categorization based on context of the plurality of items. In an embodiment, the categorization can be a hybrid categorization using a combination of predefined categories and real time categories.

As depicted in the FIG. 9c, the user can select a specific category, for example favorites, by performing a gesture (for example, a tap gesture) on that category.

As depicted in the FIG. 9d, when the user selects the category favorites, the contact items that are categorized in the category favorites are displayed to the user.

As depicted in the FIG. 9e, the user de-categorizes the categories by performing a gesture (for example, a spread gesture) on the displayed categories.

As depicted in the FIG. 9f, when the user performs the gesture to de-categorize, then the categorized contact items are de-categorized as individual contact items.

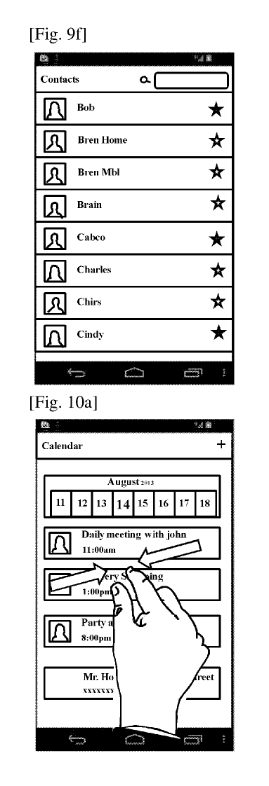

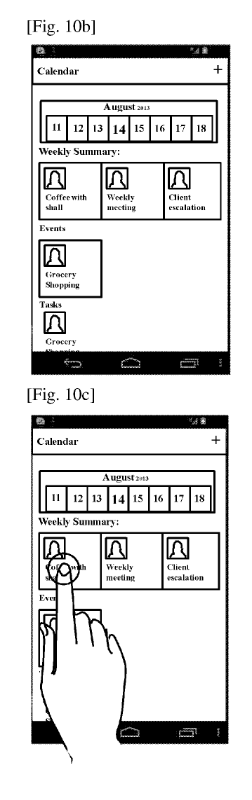

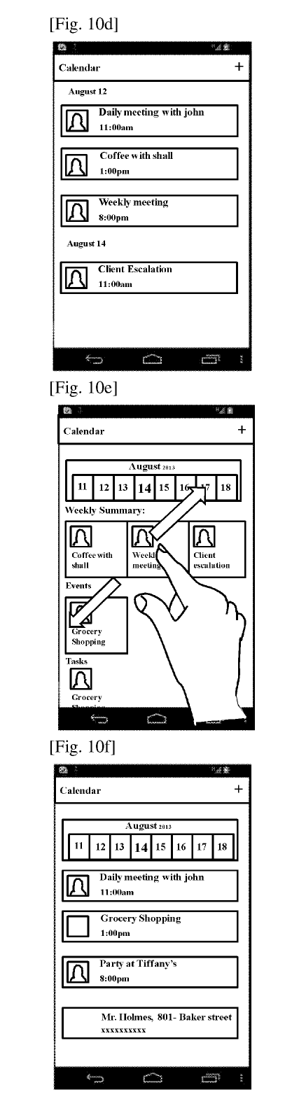

FIGS. 10a-10f illustrates an example of organizing calendar items when a user performs a gesture on the electronic device 100, according to embodiments as disclosed herein. As depicted in the FIG. 10a, the electronic device 100 displays calendar items of Aug. 14, 2013. The user performs a gesture (for example, a pinch gesture) on the calendar items.

When the user performs a gesture (for example, a pinch gesture) on the screen of the calendar items, the items are categorized into one or more categories such as weekly summary, tasks and groups and so on with metadata as depicted in the FIG. 10b. In an embodiment, the organizing module 102 categorizes the calendar items.

In an embodiment, the categories can be predefined categories configured by the user. In an embodiment, the predefined categories are available externally to the electronic device 100. In an embodiment, the categorization can be a real time categorization based on context of the plurality of items. In an embodiment, the categorization can be a hybrid categorization using a combination of predefined categories and real time categories.

As depicted in the FIG. 10c, the user can select a specific category, for example weekly summary, by performing a gesture (for example, a tap gesture) on that category.

As depicted in the FIG. 10d, when the user selects the category weekly summary, the calendar items that are categorized in the category are displayed to the user.

As depicted in the FIG. 10e, the user can de-categorize the categories by performing a gesture (for example, a spread gesture) on the displayed categories.

As depicted in the FIG. 10f, when the user performs the gesture to de-categorize, then the categorized calendar items are de-categorized as individual calendar items.

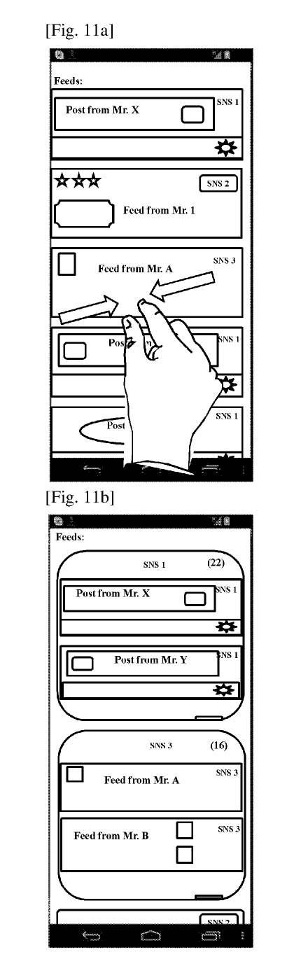

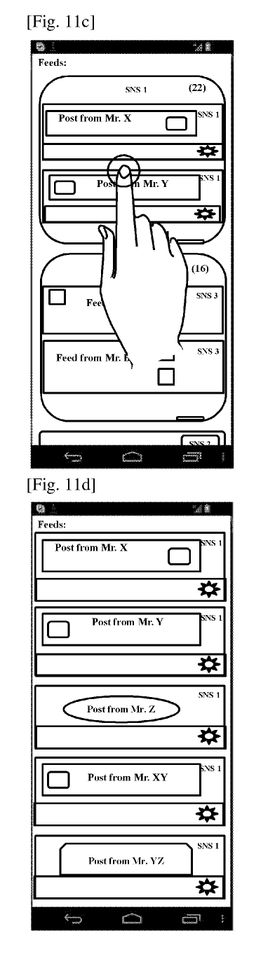

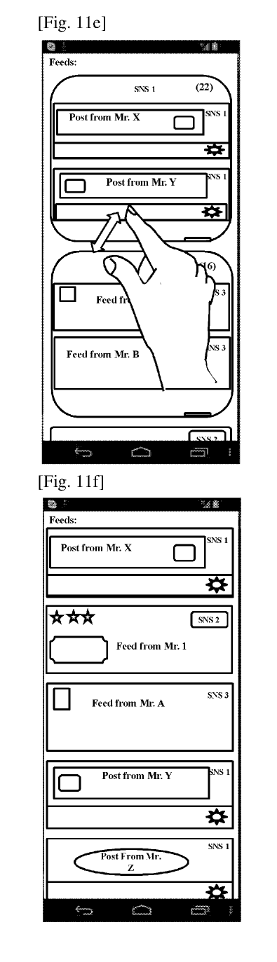

FIGS. 11a-11f illustrates an example of organizing feeds when a user performs a gesture on the electronic device 100, according to embodiments as disclosed herein. As depicted in the FIG. 11a, the electronic device 100 displays feed items from different SNS. The user performs a gesture (for example, a pinch gesture) on the feed items from different SNS.

When the user performs a gesture (for example, a pinch gesture) on the screen of the feed items, the items are categorized into one or more categories such as SNS 1, SNS 2, SNS 3, and so on with metadata as depicted in the FIG. 11b. In an embodiment, the organizing module 102 categorizes the feed items.

In an embodiment, the categories can be predefined categories configured by the user. In an embodiment, the predefined categories are available externally (SNS) to the electronic device 100. In an embodiment, the categorization can be a real time categorization based on context of the plurality of items. In an embodiment, the categorization can be a hybrid categorization using a combination of predefined categories and real time categories.

As depicted in the FIG. 11c, the user can select a specific category, for example SNS 1, by performing a gesture (for example, a tap gesture) on that category.

As depicted in the FIG. 11d, when the user selects the SNS 1 category, the feed items that are categorized under the SNS 1 category are displayed to the user.

As depicted in the FIG. 11e, the user can de-categorize the categories by performing a gesture (for example, a spread gesture) on the displayed categories.

As depicted in the FIG. 11f, when the user performs the gesture to de-categorize, then the categorized feed items are de-categorized as individual feed items.

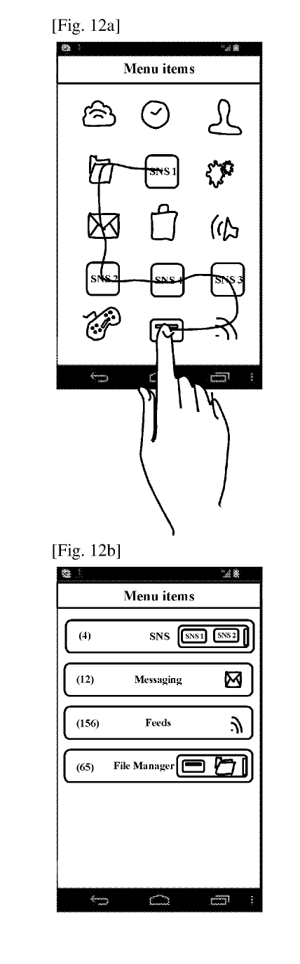

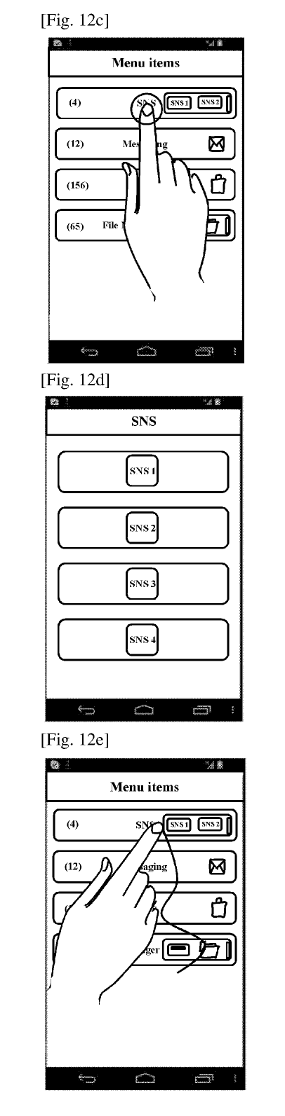

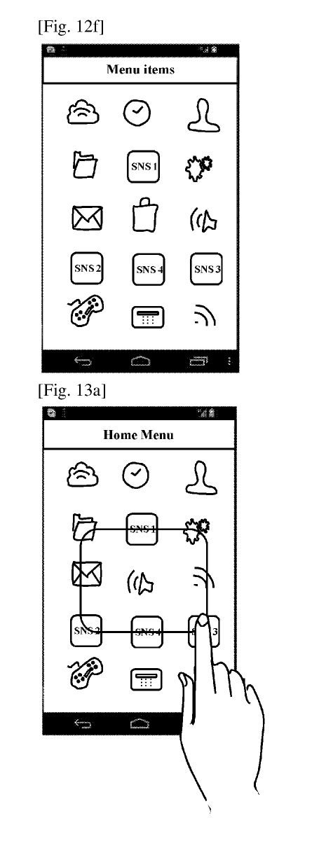

FIGS. 12a-12f illustrates another example of organizing menu items when a user performs a gesture on the electronic device 100, according to embodiments as disclosed herein. As depicted in the FIG. 12a, the electronic device 100 displays menu items. The user performs a gesture (non-uniform) on a set of menu items from plurality of menu items. As depicted in the FIG. 12a, the gesture performed by the user selects four SNS applications, a text messaging application, two file manager applications and a feed application.

When the user performs a gesture on the screen of set of menu items, the items are categorized into one or more categories such as SNS, messaging, feeds, and file manager with metadata as depicted in the FIG. 12b. In an embodiment, the organizing module 102 categorizes the set of menu items.

In an embodiment, the categories can be predefined categories configured by the user. In an embodiment, the predefined categories are available externally to the electronic device 100. In an embodiment, the categorization can be a real time categorization based on context of the plurality of items. In an embodiment, the categorization can be a hybrid categorization using a combination of predefined categories and real time categories.

As depicted in the FIG. 12c, the user selects a specific category, for example SNS, by performing a gesture (for example, a tap gesture) on that category.

As depicted in the FIG. 12d, when the user selects the SNS category, the SNS applications that are categorized under the SNS category are displayed to the user.

As depicted in the FIG. 12e, the user de-categorizes the categories by performing a gesture (non-uniform) on the displayed categories.

As depicted in the FIG. 12f, when the user performs the gesture to de-categorize, then the categorized set of items are de-categorized as individual menu items.

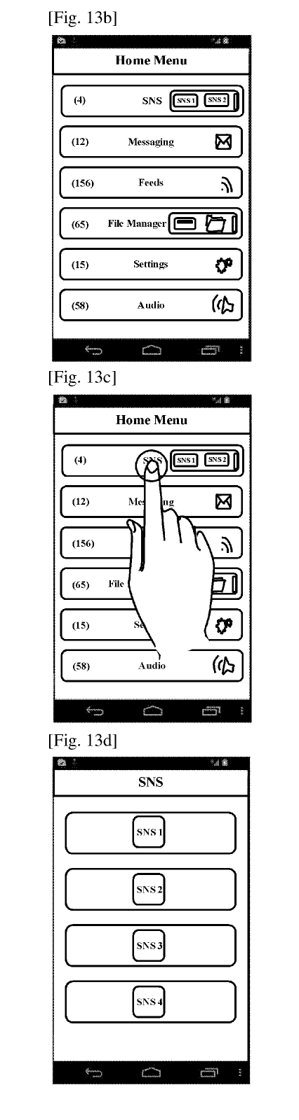

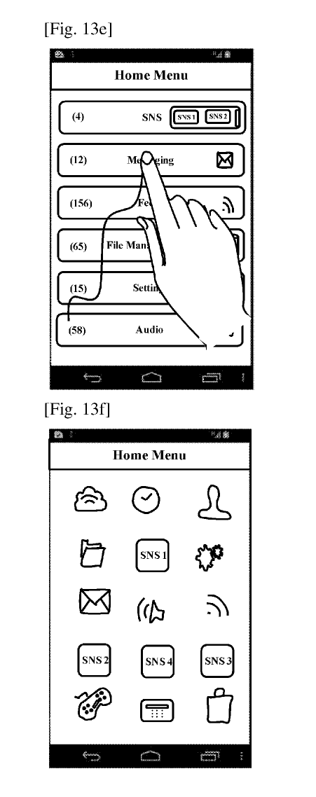

FIGS. 13a-13f illustrates another example of organizing menu items when a user performs a gesture on the electronic device 100, according to embodiments as disclosed herein. As depicted in the FIG. 13a, the electronic device 100 displays menu items. The user performs a gesture on a set of menu items from plurality of menu items. As depicted in the FIG. 13a, the gesture performed by the user selects four SNS applications, a text messaging application, a file manager application, a phone settings application, a media player application and a feed application.

When the user performs a gesture (for example, a closed gesture as depicted in the FIG. 13a) on the screen of set of menu items, the items are categorized into one or more categories such as SNS, messaging, feeds, settings, audio and file manager with metadata as depicted in the FIG. 13b. In an embodiment, the organizing module 102 categorizes the set of menu items.

In an embodiment, the categories can be predefined categories configured by the user. In an embodiment, the predefined categories are available externally to the electronic device 100. In an embodiment, the categorization can be a real time categorization based on context of the plurality of items. In an embodiment, the categorization can be a hybrid categorization using a combination of predefined categories and real time categories.

As depicted in the FIG. 13c, the user selects a specific category, for example SNS, by performing a gesture (for example, a tap gesture) on that category.

As depicted in the FIG. 13d, when the user selects the SNS category, the SNS applications that are categorized under the SNS category are displayed to the user.

As depicted in the FIG. 13e, the user can de-categorize the categories by performing a gesture (for example, a gesture from bottom to top as depicted in the FIG. 12e) on the displayed categories.

As depicted in the FIG. 13f, when the user performs the gesture to de-categorize, then the categorized set of menu items are de-categorized as individual menu items as depicted in FIG. 13a.

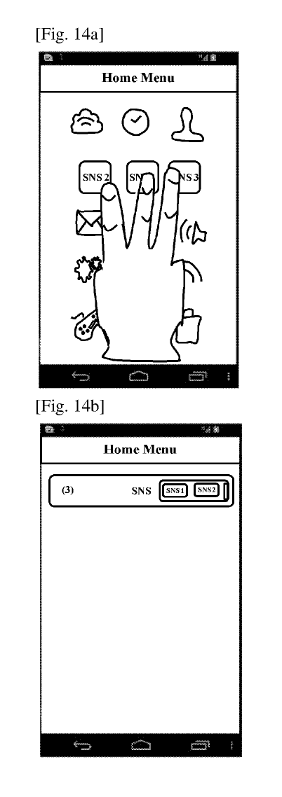

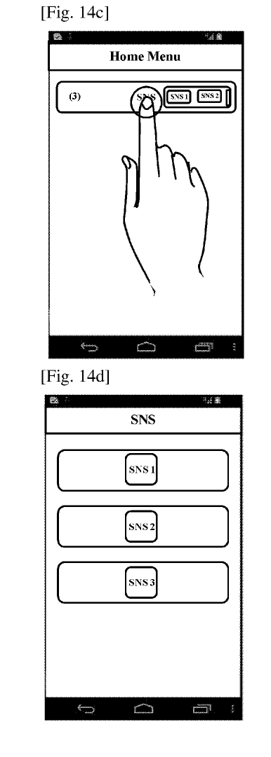

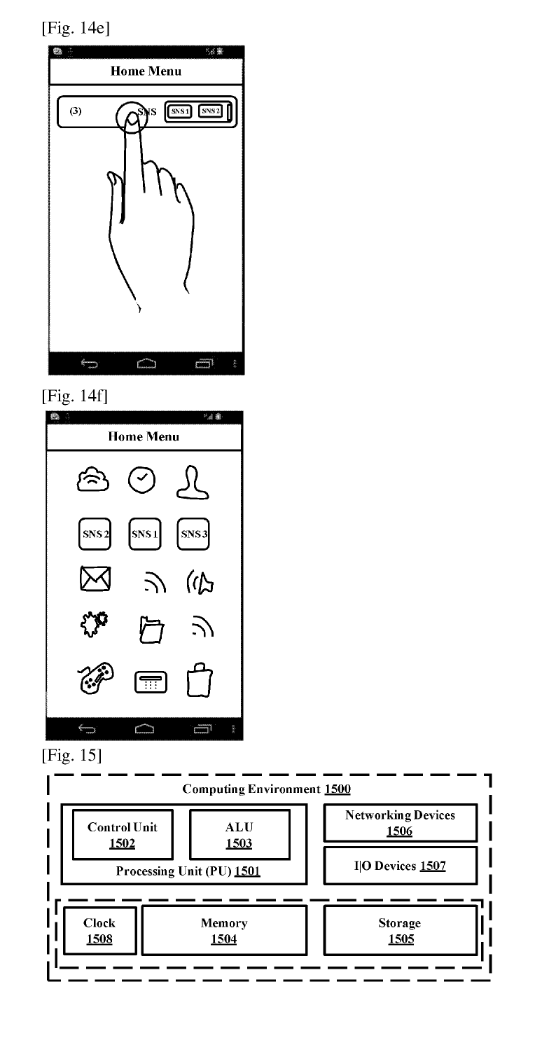

FIGS. 14a-14f illustrates another example of organizing menu items when a user performs a gesture on the electronic device 100, according to embodiments as disclosed herein.

As depicted in the FIG. 14a, the electronic device 100 displays menu items. The user performs a gesture (multi-touch) on a set of menu items from plurality of menu items. As depicted in the FIG. 14a, the gesture performed by the user selects three SNS applications.

When the user performs a gesture (multi-touch) on the screen of set of menu items, the items are categorized into category SNS with metadata as depicted in the FIG. 14b. In an embodiment, the organizing module 102 categorizes the set of menu items along with metadata.

In an embodiment, the categories can be predefined categories configured by the user. In an embodiment, the categorization can be a real time categorization based on context of the plurality of items. In an embodiment, the categorization can be a hybrid categorization using a combination of predefined categories and real time categories.

As depicted in the FIG. 14c, the user can select the category SNS, by performing a gesture (for example, a tap gesture) on that category.

As depicted in the FIG. 14d, when the user selects the SNS category, the SNS applications that are categorized under the SNS category are displayed to the user.

As depicted in the FIG. 14e, the user de-categorizes the categories by performing a gesture (for example, a tap gesture) on the displayed categories.

As depicted in the FIG. 14f, when the user performs the gesture to de-categorize, then the categorized set of menu items are de-categorized as individual menu items.

FIG. 15 illustrates a computing environment implementing the method to organize the plurality of items on the electronic device 100 based on a gesture, according to embodiments as disclosed herein. As depicted in the figure, the computing environment 1500 comprises at least one processing unit 1501 that is equipped with a control unit 1502 and an Arithmetic Logic Unit (ALU) 1503, a memory 1504, a storage unit 1505, plurality of networking devices 1506 and a plurality Input output (I/O) devices 1507. The processing unit 1501 is responsible for processing the instructions of the algorithm. The processing unit 1501 receives commands from the control unit 1502 in order to perform its processing. Further, any logical and arithmetic operations involved in the execution of the instructions are computed with the help of the ALU 1503.

The algorithm comprising of instructions and codes required for the implementation are stored in either the memory unit 1504 or the storage 1505 or both. At the time of execution, the instructions may be fetched from the corresponding memory 1504 and/or storage 1505, and executed by the processing unit 1501.

In case of any hardware implementations various networking devices 1507 or external I/O devices 1506 may be connected to the computing environment to support the implementation through the networking unit and the I/O device unit. The embodiments disclosed herein can be implemented through at least one software program running on at least one hardware device and performing network management functions to control the network elements.

The embodiments disclosed herein can be implemented through at least one software program running on at least one hardware device and performing network management functions to control the elements. The elements shown in FIGS. 1 and 15 include blocks which can be at least one of a hardware device, or a combination of hardware device and software module.

The embodiment disclosed herein specifies a method and device for organizing a plurality of items on an electronic device. The method allows organizing the plurality of items on the electronic device by identifying a gesture providing a system thereof. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method for organizing a plurality of items on an electronic device, the method comprising:
identifying at least one gesture performed by a user on the plurality of items;
identifying at least one category for the plurality of items according to one or more relations between the plurality of items in response to the identified at least one gesture; and
organizing the plurality of items based on the at least one identified category.

2. The method of claim 1, wherein organizing the plurality of items comprises one of categorizing the plurality of items into the at least one identified category and de-categorizing the plurality of items into the at least one identified category.

3. The method of claim 1, wherein the method further comprises displaying the plurality of items in the at least one category in response to the organizing

4. The method of claim 1, wherein the gesture is one of a single touch gesture, a multi-touch gesture, and a hover gesture.

5. The method of claim 1, wherein the organizing the plurality of items based on the least one identified category comprises:
identifying a set of items among the plurality of items covered by the at least one identified gesture; and
categorizing the set of identified items into the at least one identified category.

6. The method of claim 1, wherein the organizing the plurality of items based on the least one identified category comprises:
identifying a set of categorized items covered by the at least one identified gesture; and
de-categorizing the set of categorized items into the at least one identified category.

7. An electronic device for organizing a plurality of items, the electronic device comprising:
an integrated circuit further comprising at least one processor;
at least one memory having a computer program code within the circuit;
the at least one memory and the computer program code with the at least one processor cause the electronic device to:
identify at least one gesture performed by a user on the plurality of items;
identify at least one category for the plurality of items according to one or more relations between the plurality of items in response to the identified at least one gesture; and
organize the plurality of items based on the least one identified category.

8. The electronic device of claim 7, wherein the organizing the plurality of items comprises one of: categorizing the plurality of items into the at least one identified category, and de-categorizing the plurality of items into the at least one identified category.

9. The electronic device of claim 7, wherein the electronic device is further configured to display the plurality of items in the at least one category in response to the organizing

10. The electronic device of claim 7, wherein the gesture is one of: a single touch gesture, multi-touch gesture, and a hover gesture.

11. The electronic device of claim 7, wherein the organizing the plurality of items based on the least one identified category comprises:
identifying a set of items among the plurality of items covered by the at least one identified gesture; and
categorizing the set of identified items into the at least one the identified category.

12. The electronic device of claim 7, wherein the organizing the plurality of items based on the least one identified category comprises:
identifying a set of categorized items covered by the at least one identified gesture; and
de-categorizing the set of categorized items into the at least one identified category.

13. A computer program product comprising computer executable program code recorded on a computer readable non-transitory storage medium, the computer executable program code when executed, causing the actions including:
identifying at least one gesture performed by a user on the plurality of items;
dynamically identifying at least one category for the plurality of items according to one or more relations between the plurality of items in response to the identified at least one gesture; and
organizing the plurality of items based on the least one identified category.

14. The computer program product of claim 13, wherein organizing the plurality of items comprises one of: categorizing the plurality of items into the at least one identified category, and de-categorizing the plurality of items into the at least one identified category.

15. The computer program product of claim 13, wherein the computer executable program code when executed, cause further actions including displaying the plurality of items in the at least one category in response to the organizing

16. The computer program product of claim 13, wherein the gesture is one of a single touch gesture, multi-touch gesture, and a hover.

17. The computer program product of claim 13, wherein the organizing the plurality of items based on the least one identified category comprises:
identifying a set of items among the plurality of items covered by the at least one identified gesture; and
categorizing the set of identified items into the at least one the category.

18. The computer program product of claim 13, wherein the organizing the plurality of items based on the least one identified category comprises:
identifying a set of categorized items covered by the at least one identified gesture; and
de-categorizing the set of categorized items into the at least one identified category.
